(19) United States
(12) Patent Application Publication
(10) Pub. No.: US 2023/0235207 A1
(43) Pub. Date: Jul. 27, 2023

(54) Adhesive for Attaching Objects to a Surface

(71) Applicant: Leaf Shave Company, Pittsburgh, PA (US)

(72) Inventor: Benjamin McCandless, Captain Cook, HI (US)

(21) Appl. No.: 18/101,838

(22) Filed: Jan. 26, 2023

Related U.S. Application Data
(60) Provisional application No. 63/303,685, filed on Jan. 27, 2022.

(51) Int. Cl. C09J 191/06; C09J 193/04; C09J 11/04; C09J 11/08; C09J 5/00; A45D 27/29

(52) U.S. Cl. CPC C09J 191/06; C09J 193/04; C09J 11/04; C09J 11/08; C09J 5/00; A45D 27/29

(57) ABSTRACT

An adhesive for forming a water tight seal, including: a resin, being insoluble in water; a wax, being moldable and combined with the resin to form a combination, the wax combine with the resin to increase the ductility of the combination; and a binding agent, the binding agent being combined with the combination to increase the viscosity of the combination; where the resin, the wax, and binding agent are combined to form the adhesive.

### CROSS REFERENCE TO RELATED APPLICATIONS

This application claims benefit of U.S. Provisional Patent Application No. 63/303,685 filed Jan. 27, 2022, the disclosure of which is incorporated by reference.

### BACKGROUND OF THE INVENTION

### Field of the Invention

The present invention is in the field of shaving products and their construction. More specifically, the present invention relates to adhesives for attaching shaving products.

### Description of Related Art

The use of shaving-related products often occurs in the bathroom with limited space. In particular, shaving razors tend to be used at the sink or in the shower. Users desire a stand to ensure that the razors are kept in a safe location from accidental damage, while still convenient. The primary locations where a stand would be used are near sinks used for shaving and in bathing/showering areas. In these locations, it is desirable to have stands designed to work with horizontal and vertical surfaces. Stands for horizontal surfaces tend to be straightforward to design, easily hold the product on a counter or shelf. Vertical stands are of interest in locations where horizontal surfaces are limited, such as in a shower where limited space is available.

Fastening vertical stands typically requires the use of a permanent physical fastener such as a screw, removable physical fastener such as a suction cup, or an adhesive. While permanent physical fasteners offer the greatest security, they tend to be unpopular in the bathroom use as they frequently require the user to drill through glass or tile and creates a permanent defect. Temporary physical fasteners are reasonably popular—it is relatively easy to find bathroom products using a suction cup for fastening. The disadvantage is these tend to be insecure, suction cups only perform well when used on very smooth and non-porous surfaces, and the presence of any dirt, dust, or flaw in the substrate can result in a weak attachment.

Therefore, there is a need for an adhesive attachment mechanism. Adhesives can be designed to be compatible with many different surface materials and roughnesses. They can provide a strong and reliable attachment. Many adhesives are straightforward to remove and clean up, in the event that the consumer wishes to reposition or completely remove the adhered item.

Further, many adhesives include petrochemicals and animal products which results in significant waste as the byproduct of using petrochemicals and animal products may be toxic or inhumane. Therefore, there is a need for a petrochemical and animal product free adhesive.

### SUMMARY OF THE INVENTION

In one embodiment, an adhesive for forming a water tight seal, comprises: a resin, being insoluble in water; a wax, being moldable and combined with the resin to form a combination, the wax combined with the resin to increase the ductility of the combination; and a binding agent, the binding agent being combined with the combination to increase the viscosity of the combination; wherein the resin, the wax, and binding agent are combined to form the adhesive.

In another embodiment, the adhesive for forming a water tight seal, wherein the combination comprises of 100 parts of the resin, 10-50 parts of the wax, and 10-100 parts of the binding agent.

In another embodiment, the adhesive for forming a water tight seal, wherein the binding agent is diatomaceous earth or cellulose fiber.

In another embodiment, the adhesive for forming a water tight seal, wherein the wax is a beeswax.

In another embodiment, the adhesive for forming a water tight seal, wherein the resin comprises one of a hydrogenated rosin, glycerol ester of hydrogenated wood rosin, a chemically processed wood rosin product, or a pentaerythritol ester of hydrogenated wood rosin.

In another embodiment, the adhesive for forming a water tight seal, the adhesive forms a water tight seal between an adhesive mounting surface of a stand for a shaving razor and a surface.

In another embodiment, a stand for a shaving razor, comprises the stand comprising an adhesive mounting surface and a razor-securing surface for releasably fixing with a shaving razor; and an adhesive for forming a water tight seal, comprising a resin, being insoluble in water; a wax, being moldable and combined with the resin to form a combination, the wax combined with the resin to increase the ductility of the combination; and a binding agent, the binding agent being combined with the combination to increase the viscosity of the combination; wherein the resin, the wax, and binding agent are combined to form the adhesive which forms a water tight seal between the adhesive mounting surface of the stand and a surface.

In another embodiment, a stand for a shaving razor further comprises a vertical member extending from the razor-securing surface, wherein the vertical member and razor-securing surface are substantially round in shape.

In another embodiment, a stand for a shaving razor comprises the adhesive mounting surface is triangular in shape and the razor-securing surface is triangular in shape, the razor-securing surface forms extends from the adhesive mounting surface to form an aperture.

In another embodiment, the adhesive comprises of 100 parts of the resin, 10-50 parts of the wax, and 10-100 parts of the binding agent.

In another embodiment, the adhesive comprises the binding agent is diatomaceous earth or cellulose fiber.

In another embodiment, the resin comprises one of a hydrogenated rosin, glycerol ester of hydrogenated wood rosin, or a pentaerythritol ester of hydrogenated wood rosin.

In another embodiment, the wax is a beeswax.

In another embodiment, the adhesive, when a water tight seal is formed between the adhesive mounting surface of the stand and the surface, extends beyond the adhesive mounting surface of the stand.

In another embodiment, a method for forming an adhesive, comprises: combining a wax, being moldable, and a resin, being insoluble in water, forming a combination; and combining the combination with a binding agent increasing ductility of the combination.

In another embodiment, a method for forming an adhesive, the adhesive comprised of 100 parts of the resin, 10-50 parts of the wax, and 10-100 parts of the binding agent.

In another embodiment, a method for forming an adhesive, comprises the binding agent is diatomaceous earth or cellulose fiber.

In another embodiment, a method for forming an adhesive, comprises: the resin comprises one of a hydrogenated rosin, glycerol ester of hydrogenated wood rosin, or a pentaerythritol ester of hydrogenated wood rosin.

In another embodiment, a method for forming an adhesive comprises a wax, wherein the wax is a beeswax.

In another embodiment, a method for forming an adhesive, comprises: a water tight seal is formed between an adhesive mounting surface of a shaving razor stand and a surface with the adhesive.

### BRIEF DESCRIPTION OF THE DRAWINGS

FIG. 1 is a perspective view of an embodiment of a shaving razor stand;

FIG. 2 is a perspective view of an embodiment of a shaving razor stand;

FIG. 3A is a perspective view of an embodiment of a shaving razor stand;

FIG. 3B is a side view of an embodiment of a shaving razor stand;

FIG. 4A is a front side view of an embodiment of a shaving razor stand;

FIG. 4B is a back side view of an embodiment of a shaving razor stand;

FIG. 5A is a perspective view of an embodiment of a shaving razor stand and shaving razor;

FIG. 5B is a side view of an embodiment of a shaving razor stand and shaving razor;

FIG. 5C is a back side view of an embodiment of a shaving razor stand and shaving razor; and

FIG. 6 is a cross-sectional view of a shaving razor stand fixed to a surface.

### DESCRIPTION OF THE INVENTION

Embodiments of the invention will now be described with reference to the accompanying figures, wherein like numerals refer to like elements throughout. The terminology used in the description presented herein is not intended to be interpreted in any limited or restrictive manner simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

The adhesive was developed with certain parameters such as being petrochemical free and animal product free. The adhesive, when in use, required performance characters such as nontoxic or not hazardous to the user; being waterproof or able to maintain a seal in a wet environment such as a bathroom, sink, or shower; being rot-resistant or able to resist degradation due to long-term exposure to humidity or standing water, commonly found in a bathroom setting; being able to adhere to a variety of surfaces with varying textures such as slate, tile, and glass; being strong enough to handle shear and tensile loads that are common or expected for securing fixtures in bathroom settings; being easy to apply to a variety of surfaces; being easy to remove from a surface without damaging the surface to which it was applied; and consistency of the material properties.

Prior to the invention of modern adhesives, commonly used adhesives were made from: vegetable starches such as a flour-water paste; animal proteins such as hide glues; and plant resins such as pine tar. These compounds (referred to here as bioadhesives), have almost certainly been used since prehistoric times.

Vegetable starch-based adhesives were used by the ancient Egyptians to bond papyrus to clothing. Manufacturing these adhesives is quite simple, frequently only requiring the mixing of a grain flour (wheat, rice, or others) with water to create a paste. This paste is then applied to the surfaces to be adhered, the surfaces are then pressed together. Once the paste has dried, the bond will have reached its maximum strength. While quite simple to manufacture, the resulting bond can be dissolved if exposed to water.

Animal protein-based adhesives are found in the archaeological record dating back at least 6,000 years ago. These adhesives were used for the manufacture of wooden goods, such as furniture and weaponry, by the ancient Egyptians. The Greeks and Romans made significant contributions to the development of these adhesives, and the Mongols used them to fashion compact and powerful bows, which contributed to their conquest of much of Asia.

Resin-based adhesives are most-likely the oldest adhesive, being originally used to make hand tools, with some examples dating back to 200,000 years ago. A wide variety of resin adhesive formulations are found in the archaeological record, but a mixture of resin or resin product, such as tar or pitch, and some sort of a binding agent, such as ochre, is relatively common. While the resin provides adhesive properties, the use of a filler produces a composite material that can be significantly stronger and more resistant to environmental conditions than the resin alone. A mixture commonly known as Cutler's Resin has been used since antiquity to fasten blades to handles, and the Romans developed the technique of using tar and beeswax to seal wooden planks together when building boats and ships.

While these bioadhesives were used extensively prior to the development of modern synthetic adhesives, it is now fairly uncommon to find them in consumer applications. Modern synthetic adhesives as a whole tend to have better strength, shelf life, and are easier to apply, as such, these bioadhesives have been largely abandoned for consumer use. However, bioadhesives do still find varying use in certain industrial applications. Paper products such as cardboard and wallpaper are frequently adhered using starch-based adhesives, and casein adhesives are commonly used to attach labels to glass bottles. In the household environment, the most common adhesives are Polyvinyl Acetate based such as Elmer's Glue™, most wood glues and similar products, cyanoacrylates such as super glues, and epoxies. Formerly common adhesives such as mucilage, a plant starch-based adhesive, are not widely sold for consumer use.

With the need for a non-synthetic adhesive, the three major categories of bioadhesives were examined for suitability. Vegetable Starch-based adhesives are sensitive to water and can provide a food source for microorganisms. As such, they include significant drawbacks for a product that will be used in wet environments, such as bathrooms. Animal-based adhesives contribute to waste as the byproduct of using petrochemicals and animal products may be toxic or inhumane. The remaining option, resin-based adhesives provide the necessary qualities, as these adhesives are resistant to moisture, can be applied to a variety of surfaces, can be quite strong, and can be applied and removed through the application of heat.

Cutler's resin, as mentioned above, is a mixture of pitch, wax, and a form of a binding agent. As a hot-melt adhesive, it is used by heating it until it is soft or fully liquid, applying it to the components to be adhered, and then pressing the components together until the resin has cooled. The resulting bond can be strong and resistant to water.

The pitch used previously by various cultures was determined by the available sources. While conifers are the most common sort, other trees, such as birch, can produce a resinous pitch as well. Given the wide variety of pitch-bearing trees around the world, every culture using Cutler's resin developed recipes from locally sourced materials that suited their needs. Some versions of Cutler's resin call for raw pitch, but others would partially burn the resin, releasing the most volatile components and leaving behind a tar residue which could also be used.

The function of the wax within the resin mixture is to make the end product somewhat less sticky when cooled and solidified, increasing the ductility, and decreasing water sensitivity of the final resin. Pure pitch can be frangible when subject to shock loads as it can crack easily and will be reduced to powder by continuous use in dry environments. In environments where water is present, pitches may soften and become so sticky that dust and debris from the environment becomes embedded in the resin. The addition of wax may mitigate all of these issues.

A wide variety of natural binding agents have been found in use such as charcoal, which has a high surface area to volume ratio, and moose, or similar, dung which contains undigested plant fibers. In either example, the properties of the binder act to increase the viscosity of the resin mixture, making it easier to apply an appropriate quantity to the items to be adhered together. Currently, Cutler's resin may be considered to be an artisanal product as it is typically produced in small quantities to support the production of historically accurate knives and similar tools. Modern synthetic epoxy resins appear to have entirely replaced Cutler's resin in the manufacture of consumer and industrial products. Given that that products referred to as Cutler's resins may be produced by a wide variety of recipes, there is little uniformity in their properties, and in many cases, the properties of the various mixtures vary substantially depending on the source of the resin, the type of binder used, and the relative ratios of the three primary ingredients.

The properties of raw resins or untreated resins have a low melting temperature and there is a lack of uniformity and consistency of the source material. Since uniformity is highly desirable for any commercial product, consistency and uniformity is greatly sought after. While currently there are limited commercial or industrial applications of Cutler's resin, a variety of refined resin products are used in various applications. Many synthetic adhesives add refined resin products as a tackifier, which increases the stickiness of a product. This is commonly seen in pressure sensitive adhesives, like tape. A variety of resin products are produced by chemically processing raw resin and are available in industrial quantities.

The sourcing of wax was more straightforward; since synthetic and petroleum based waxes are undesirable for this invention, beeswax was a reasonable substitute. While there is some variability in beeswax from different hives, the overall properties are generally quite similar. As an additional benefit for the environmentally-conscious, many apiaries sell beeswax from hives used to service organic farms, where the bees involved are not exposed to commercial pesticides.

Since both the resin and the wax are naturally water resistant, and more so when mixed, their characteristics and performance in damp environments such as a bathroom are desired. However, a binding material made with organic material is more likely to provide nutrients for the growth of bacteria, which is highly undesirable for an adhesive that may be used in bathrooms or other warm, moist environments. The use of materials that might stain tile or stone is also undesirable. Many of the classic binding agents mentioned are therefore undesirable; taking the examples mentioned above, charcoal powder can be very fine and leave a black stain on porous surfaces, while moose or similar dung is full of decaying organic material.

However diatomaceous earth, which consists of the fossilized silica-based shells of a type of algae, deposited as a form of sedimentary rock on the sites of certain prehistoric seas, may act as a filler. Since the organic material present in the algae cells has long since degraded, the remaining material consists of a highly porous collection of spheres, tubes, and other frustules, either whole or in fragments. This material is a common garden additive which acts as an insecticide, as the silicate shells absorb lipids from the exoskeletons of many types of insects, resulting in loss of water from their bodies. It is also commonly used as a filtration media for swimming pools and aquariums, and as a food-grade additive used in livestock feed to reduce caking and to prevent insect infestation. This makes diatomaceous earth an ideal replacement for charcoal powder or other binding agents with a high surface area to volume ratio; it is readily available in non-toxic grades, it does not stain, and it does not require any animal products. Additionally, diatomaceous earth produced a uniform resin mixture.

While diatomaceous earth is an effective filler, it is not the only effective material for this use. The use of fibers also modifies the behavior of resin mixtures significantly. As mentioned above, moose or similar dung is used as a binding agent in some primitive adhesive recipes. The utility of this as an ingredient is likely due to the presence of undigested plant fibers in the dung, which modify the resin properties in desirable ways. Just as high-surface-area particles from charcoal or diatomaceous earth thicken the resin, making it easier to apply, adding long fibers can improve resin properties for particular applications. Fibers are frequently used to strengthen and/or toughen resins, as is seen in fiberglass, carbon fiber, and other modern composite materials. For the resins under development, it is desirable to have a fiber that is non-reactive with water or other common household solvents, and is available to be harvested or refined from natural, non-animal sources. Cellulose fiber meets these requirements. It is available in a variety of forms, ranging from raw cotton fibers to rayon or viscose fibers, both of which are made from wood pulp. The use of cellulose fiber of various types and lengths can be used to adjust the properties of the resin mixture as desired.

Resins can be varied to achieve specific features. Resins can be naturally or chemically adjusted to make substantial adjustments in melting temperatures such as low melting temperatures around 160 degrees F., which is the maximum desirable amount for most household applications. A variety of industrial products derived from pine resins are available in bulk. Depending on the desired melting temperature, the following rosins, solid forms of wood resin, have been used with satisfactory results: Hydrogenated rosin which produces the lowest melting temperature mixture, approximately 100 degrees F.; Glycerol ester of hydrogenated wood rosin which produces a mixture with a melting temperature of approximately 120 degrees F.; and Pentaerythritol ester of hydrogenated wood rosin which produces a mixture with a melting temperature of approximately 150 degrees F.

Effective adhesive resin mixtures have been generated using the following ratios: 100 parts of resin product, as described above; 10 to 50 parts of wax, as described above; 10 to 100 parts of binding agent such as Diatomaceous earth or cellulose fiber, as described above.

The resulting adhesive has properties that vary based on the resin selected and the particular ratios used, which can be selected based on the characteristics desired. There are a variety of applications for the adhesive. The adhesive may adhere to products made of metal, wood, plastic, glass, brick, stone, ceramic, and other relatively rigid materials to one another. The adhesive may seal cardboard boxes, apply labels to glass, plastic, wood and other materials. The adhesive may be provided in a variety of form factors such as bulk material to be shaped by the end user. Specially, shaped adhesives sheets or bricks can be supplied to customers for their own specific uses, such as standard sized sticks for use in a low temperature hot-melt glue guns, glue pots to be heated and applied with a brush, spatulas, or similar application means. Further, the adhesive may be applied by achieving a melting temperature using a hair dryer or readily available home product.

As mentioned above, there is a lack of commercial production of any modern variant of Cutler's resin. Modern synthetic adhesives are currently the only commercially available products produced that are widely used for similar purposes. While the adhesive may be used for attachment of a shaving razor stand 1, the purposes of the adhesive are not limited to such. The adhesive may be used for attaching any typical item found in a bathroom or an environment which undergoes a variety of humidity and temperature changes.

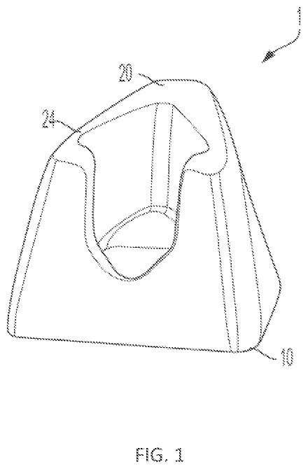

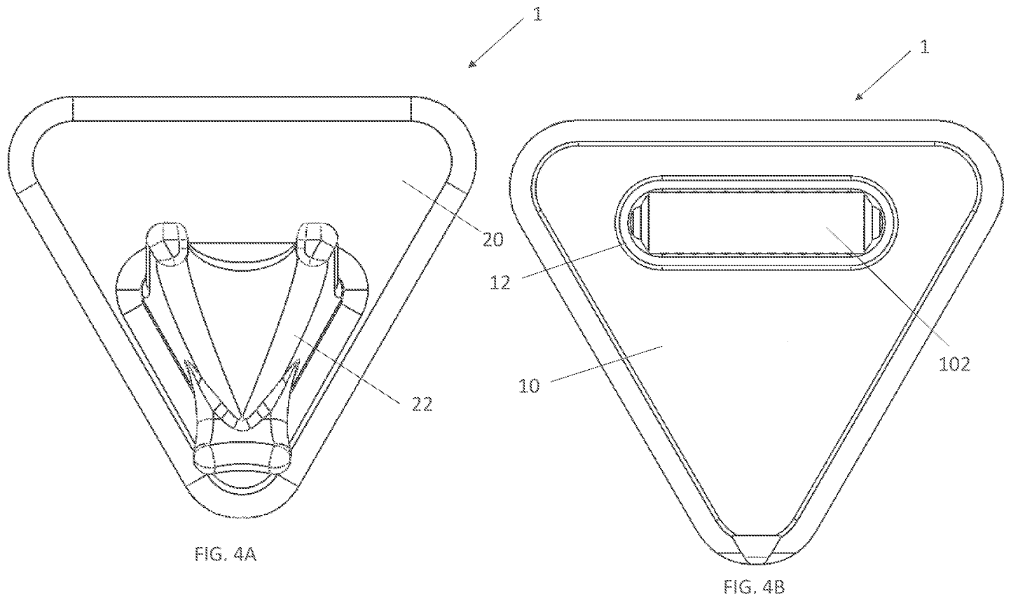

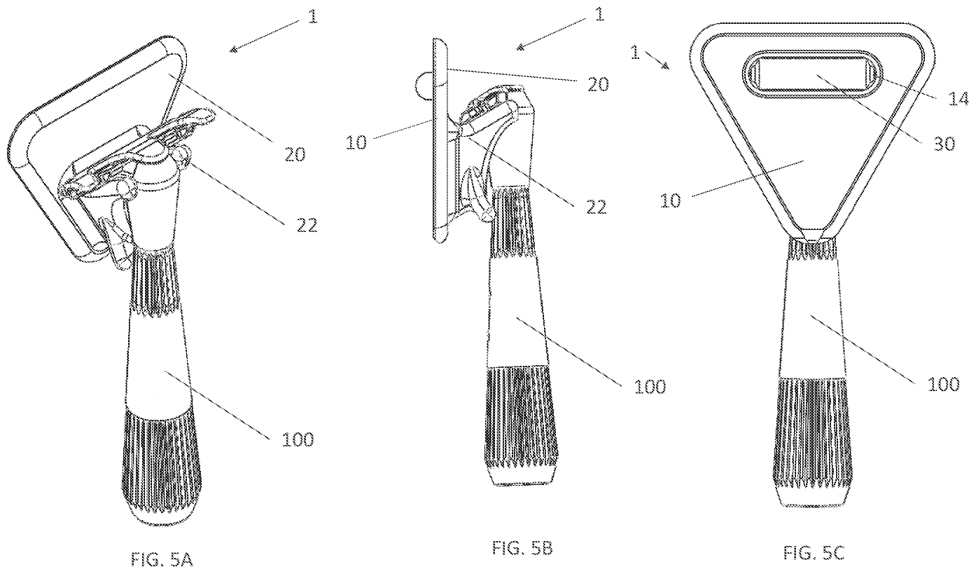

As shown in FIGS. 1-6, a stand 1 for a shaving razor includes an adhesive mounting surface 10 and a razor-securing surface 20 for releasably fixing with a shaving razor 100. The stand 1 may be made of any material similar to metal, wood, or plastic. The adhesive 30 for forming a water tight seal may be made of a resin, being insoluble in water; a wax, being moldable and combined with the resin to increase the ductility of the combination; and a binding agent, the binding agent being combined with the combination to increase the viscosity of the combination. The resin, the wax, and binding agent are combined to form the adhesive 30 which forms a water tight seal between the adhesive mounting surface 10 of the stand 1 and a surface 40 such as a bathroom counter top.

The stand 1 for a shaving razor may further include a vertical member 22 extending from the razor-securing surface 20. In one embodiment shown in FIG. 1, the adhesive mounting surface 10 is triangular in shape and the razor-securing surface 20 is triangular in shape. The razor-securing surface 20 may extends from the adhesive mounting surface 10 to form an aperture 24 within the vertical member 22.

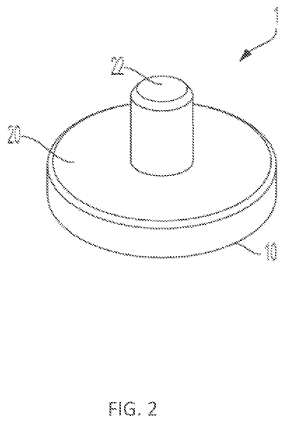

In one embodiment shown in FIG. 2, the vertical member 22 and razor-securing surface 20 are substantially round in shape. The vertical member 22 extends from the center of the razor-securing surface 20 to form an attachment means.

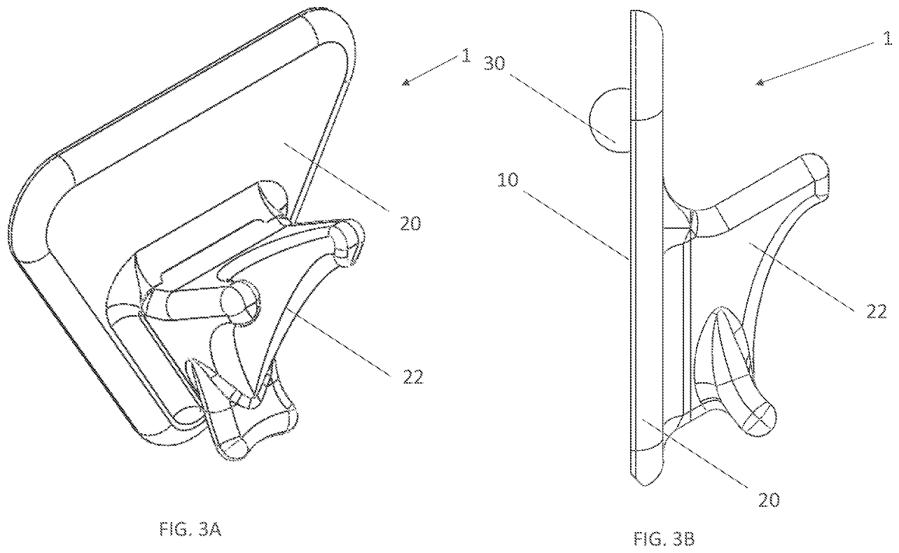

Another embodiment of a shaving razor stand 1 is shown in FIGS. 3-5. As shown, the shaving razor stand 1 includes an adhesive mounting surface 10 and a razor-securing surface 20 for releasably fixing with a shaving razor. The resin, the wax, and binding agent are combine to form the adhesive 30 which forms a water tight seal between the adhesive mounting surface 10 of the stand 1 and a surface 40 such as a bathroom wall or vertical surface 50. The vertical member 20 may include hooks or handles 24 which operate as an attachment means for a razor 100. The adhesive mounting surface 10 may include an adhesive pad 12 configured to fit the adhesive 30. The adhesive pad 12 may have ribs 14 be shaped, grooved, or configured to have an increased surface area to be better adhered to.

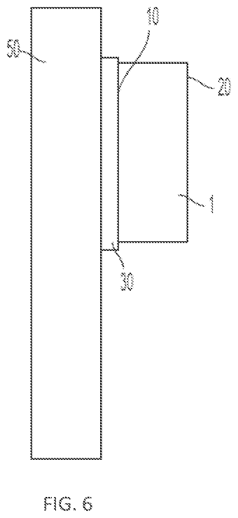

As shown in FIG. 6, the adhesive 30 may adhere the stand 1 to a vertical surface 50. The adhesive 30 may extend past the adhesive mounting surface 10 such that it is ensured that the adhesive 30 contacts the full adhesive mounting surface 10 of the stand 1. The adhesive 30, when pressed against a surface may expand and cover all of the razor-securing surface 20. The adhesive 30 may even expand past the surface 20.

Advantageously, the adhesive 30, when in use, is nontoxic or not hazardous to the user; is waterproof or able to maintain a seal in a wet environment such as a bathroom, sink, shower; is rot-resistant or able to resist degradation due to long-term exposure to humidity or standing water, commonly found in a bathroom setting; is able to adhere to a variety of surfaces with varying textures such as slate, tile, and glass; is strong to handle shear and tensile loads that are common or expected for securing fixtures in bathroom settings; is easy to apply to a variety of surfaces; is easy to remove from a surface without damaging the surface to which it was applied; and is consistent with the material properties.

The invention claimed is:

1. An adhesive for forming a water tight seal, comprising:
a resin, being insoluble in water;
a wax, being moldable and combined with the resin to form a combination, the wax combined with the resin to increase the ductility of the combination; and
a binding agent, the binding agent being combined with the combination to increase the viscosity of the combination;
wherein the resin, the wax, and binding agent are combined to form the adhesive.

2. The adhesive for forming a water tight seal of claim 1, wherein the combination comprises of 100 parts of the resin, 10-50 parts of the wax, and 10-100 parts of the binding agent.

3. The adhesive for forming a water tight seal of claim 1, wherein the binding agent is diatomaceous earth or cellulose fiber.

4. The adhesive for forming a water tight seal of claim 1, wherein the wax is a beeswax.

5. The adhesive for forming a water tight seal of claim 1, wherein the resin comprises one of a hydrogenated rosin, glycerol ester of hydrogenated wood rosin, a chemically processed wood rosin product, or a pentaerythritol ester of hydrogenated wood rosin.

6. The adhesive for forming a water tight seal of claim 1, the adhesive forms a water tight seal between an adhesive mounting surface of a stand for a shaving razor and a surface.

7. A stand for a shaving razor, comprising:
the stand comprising an adhesive mounting surface adhesive mounting surface and a razor-securing surface for releasably fixing with a shaving razor; and
an adhesive for forming a water tight seal, comprising a resin, being insoluble in water; a wax, being moldable and combine with the resin to form a combination, the wax combine with the resin to increase the ductility of the combination; and a binding agent, the binding agent being combine with the combination to increase the viscosity of the combination;
wherein the resin, the wax, and binding agent are combine to form the adhesive which forms a water tight seal between the adhesive mounting surface of the stand and a surface.

8. The stand for a shaving razor of claim 7, further comprising a vertical member extending from the razor-securing surface, wherein the vertical member and razor-securing surface are substantially round in shape.

9. The stand for a shaving razor of claim 7, wherein the adhesive mounting surface is triangular in shape and the razor-securing surface is triangular in shape, the razor-securing surface forms extends from the adhesive mounting surface to form an aperture.

10. The stand for a shaving razor of claim 7, wherein the adhesive comprises of 100 parts of the resin, 10-50 parts of the wax, and 10-100 parts of the binding agent.

11. The stand for a shaving razor of claim 7, wherein the binding agent is diatomaceous earth or cellulose fiber.

12. The stand for a shaving razor of claim 7, wherein the resin comprises one of a hydrogenated rosin, glycerol ester of hydrogenated wood rosin, or a pentaerythritol ester of hydrogenated wood rosin.

13. The stand for a shaving razor of claim 7, wherein the wherein the wax is a beeswax.

14. The stand for a shaving razor of claim 7, wherein the adhesive, when a water tight seal is formed between the adhesive mounting surface of the stand and the surface, extends beyond the adhesive mounting adhesive mounting surface of the stand.

15. A method for forming an adhesive, comprising:
combining a wax, being moldable, and a resin, being insoluble in water, forming a combination; and
combining the combination with a binding agent increasing ductility of the combination.

16. The method of claim 15, wherein the adhesive comprises of 100 parts of the resin, 10-50 parts of the wax, and 10-100 parts of the binding agent.

17. The method of claim 15, wherein the binding agent is diatomaceous earth or cellulose fiber.

18. The method of claim 15, wherein the resin comprises one of a hydrogenated rosin, glycerol ester of hydrogenated wood rosin, or a pentaerythritol ester of hydrogenated wood rosin.

19. The method of claim 15, wherein the wherein the wax is a beeswax.

20. The adhesive formed according to the method of claim 15, wherein a water tight seal is formed between an adhesive mounting surface of a shaving razor stand and a surface with the adhesive.
